(19) United States
(12) Patent Application Publication
(10) Pub. No.: US 2003/0225613 A1
(43) Pub. Date: Dec. 4, 2003

(54) Method and system for customizing the content of targeted advertising

(76) Inventors: Troy Shahoumian, Sunnyvale, CA (US); Harlan Crowder, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/157,661

(22) Filed: May 28, 2002

(51) Int. Cl. G06F 17/60

(52) U.S. Cl. 705/14

(57) ABSTRACT

Embodiments of the present invention are directed to a method and system for customizing the content of targeted advertising. In one embodiment of the present invention, a record is created of in-store behavior which has at least one item of expressed interest. A targeted message is then created which has information about the item of expressed interest. The targeted message is then sent to a specific audience.

### TECHNICAL FIELD

Embodiments of the present invention are directed to the field of retail marketing methods. More specifically, embodiments of the present invention pertain to a method for customizing the content of targeted advertising.

### BACKGROUND ART

A critical task for advertisers is to deliver their message to a receptive audience. This allows advertisers to minimize advertising budgets and to customize advertisements for the same product to address particular customer segments more effectively. Thus the concept of targeted advertising is becoming more important. In an idealized model of targeted advertising, the content of the advertisement is customized to create a personalized message for each prospective customer. While this maximizes the effectiveness of the advertisement, gathering information on each likely customer is currently prohibitive both in cost and the amount of effort required. Therefore, advertisers still direct their advertising toward demographic groups rather than individual customers.

For example, radio is a popular advertising medium which relies upon listener demographics to provide advertisers fairly specific customer segments. Radio stations have relatively specific audience demographics due to the segmented nature of their listening audience. This allows advertisers to target customer segments with some degree of accuracy based upon the demographics of the radio station's listeners. However, radio advertising is still directed toward broad characterizations of listener groups rather than targeting a specific customer. Similarly, magazines provide advertisers with some degree of customer segmentation. However, as with radio, magazines can only offer broad characterizations of subscribers rather than customer specific information. Thus, with both radio and magazines, the advertiser can identify more specific customer segments which are more likely to be receptive to their message. However, most demographic groups are also likely to contain populations of disinterested consumers who are not receptive to the advertiser's message.

Modern communications media such as the Internet are increasingly used to deliver advertising that is targeted more specifically to smaller customer segments. This is possible because numerous Web sites and/or E-mails which target smaller customer segments can be created and distributed quickly and economically. As customers do business with a Web sites, the Web site gains information about them. However, Web sites initially have no demographic information about their visitors. Printed advertisements are also increasingly targeted to smaller, more specific customer segments. For example, computer controlled printing allow advertisers to more effectively target smaller customer segments because they can print small batches of advertisements more efficiently. However, to accurately identify and target customer segments, these advertising methods still need accurate customer information which may be difficult to obtain. For example, unlike a radio station, a retail Web site typically does not have a readily identified customer demographic.

Therefore, prior art methods for delivering customized advertising content to customers is problematic because of the difficulty in providing customer specific demographic information. This limits the effectiveness of new advertising media which are capable of targeting small demographic groups but lack the required information to do so accurately.

### A METHOD AND SYSTEM FOR CUSTOMIZING THE CONTENT OF TARGETED ADVERTISING IS DISCLOSED

A record is created of in-store behavior which has at least one item of expressed interest. A targeted message is then created which has information about the item of expressed interest. The targeted message is then sent to a specific audience.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description should be understood as not being drawn to scale.

FIG. 1 illustrates a method for customizing the content of targeted advertising in accordance with embodiments of the present invention.

FIG. 2 is a block diagram of a database system used in accordance with embodiments of the current invention.

FIG. 3 is a flow chart of a method for customizing content of targeted advertising in accordance with embodiments of the present invention.

FIG. 4 is a block diagram of a method for customizing the content of targeted advertising in accordance with embodiments of the present invention.

FIG. 5 illustrates a system utilizing a Bluetooth enabled device to identify an item of expressed interest in accordance with embodiments of the present invention.

FIG. 6 is a flow chart of an exemplary method for identifying an item of expressed interest in accordance with one embodiment of the present invention.

FIG. 7 is a flow chart of an exemplary method for identifying an item of expressed interest in accordance with one embodiment of the present invention.

### MODES FOR CARRYING OUT THE INVENTION

Reference will now be made in detail to embodiments of the present invention, examples of which are illustrated in the accompanying drawings. While the present invention will be described in conjunction with the following embodiments, it will be understood that they are not intended to limit the present invention to these embodiments alone. On the contrary, the present invention is intended to cover alternatives, modifications, and equivalents which may be included within the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

Embodiments of the present invention are directed to a method and system for customizing the content of targeted advertising. In accordance with embodiments of the present invention, the content of targeted advertising can be customized based upon the in-store shopping experience of a specific audience (e.g., a customer). More specifically, a customer in a store identifies a product that interests them and communicates that they would like to receive more information about that product or similar products. In one embodiment of the present invention, a record of items in which a customer has expressed an interest is created. This record is used to define a broader category of products in which the customer may also be interested. For example, this category may include the item in which the customer has expressed an interest as well as similar products and other items which may be used in conjunction with the item of expressed interest. The content of a targeted advertisement is then customized to convey information to the customer about the category of products. In other words, the advertiser (e.g., a retailer) can customize the content of advertisements sent to the customer based upon the customer's in-store behavior.

Embodiments of the present invention facilitate identifying smaller customer segments and customizing the content of targeted advertising to address these customer segments more specifically based upon their in-store behavior. In one embodiment, the present invention can be used to customize the content of targeted advertising to the level of the individual customer. This allows advertisers to create a personalized Web page or printed advertisement for a particular customer and increases the effectiveness of the advertising by addressing the customer's unique preferences. While embodiments of the present embodiment recite utilizing Web pages or printed advertisements, the present invention is well suited to utilize a variety of other communications media as well.

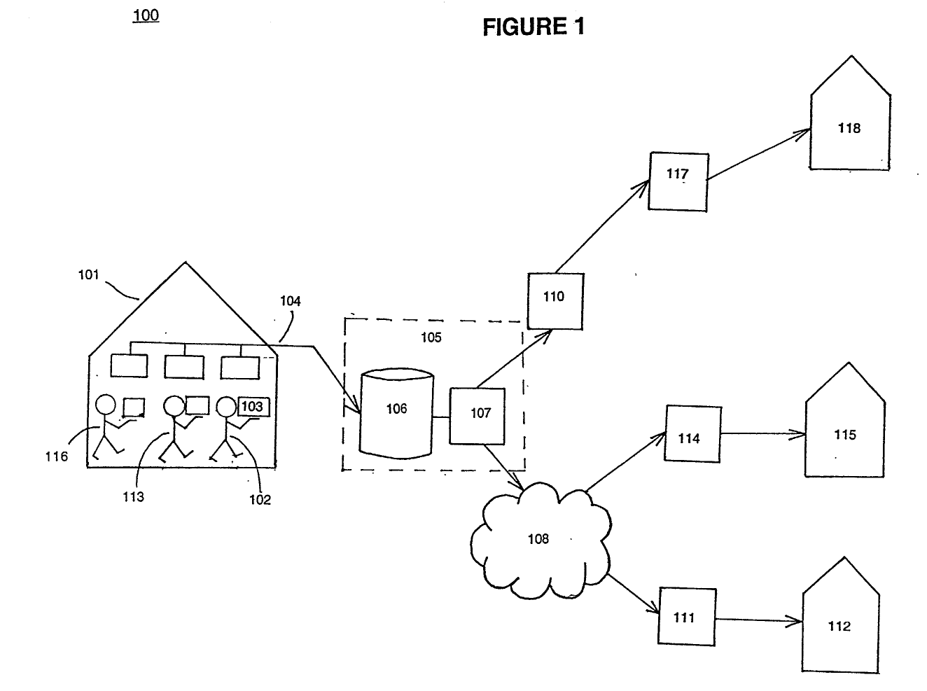

FIG. 1 illustrates a method for customizing the content of targeted advertising in accordance with embodiments of the present invention. In FIG. 1, a retailer 101 is a traditional “brick and mortar” retailer offering a product or service and is utilizing an embodiment of the present invention to gather information about in-store customer behavior in order to customize the content of a targeted advertisement which will be sent to the customer. A customer 102 expresses interest in an item 103 offered by retailer 101.

There are a variety of methods for a customer to identify item 103 as being an item of expressed interest in accordance with the present invention. Retailer 101 implements a system 104 for collecting in-store information which customer 102 uses to identify item 103. For example, in one embodiment, system 104 comprises cards which customer 102 can fill out and which indicate to retailer 101 that customer 102 is interested in item 103 and is interested in receiving additional information about item 103 and/or related items. In another embodiment, system 104 comprises a Universal Product Code (UPC) scanner can be used to record an item that the customer is interested in. For example, a retailer can distribute UPC scanners to customers as they enter the store. The customer can then scan UPC codes of items in which they are interested. Upon leaving the store, the customer returns the UPC scanner to the retailer who then downloads the UPC codes into a computer system 105.

In another embodiment, system 104 comprises credit card information. For example, customer information is easily obtained when a customer makes a purchase using a credit card, especially when retailer issued or proprietary credit cards are used to purchase item 103. Thus, credit card sales information can be stored in computer system 105 and used to customize the content of targeted advertisements sent to customer 102 from retailer 101.

In another embodiment of the present invention, system 104 comprises customer 102 using a Personal Digital Assistant (PDA) to identify item 103. For example, some PDAs can be coupled with a peripheral device to create a UPC scanner. The PDA scanner can be used to scan the UPC code on a product in which the customer is interested. Customer 102 can then download the UPC codes of item 103 into computer system 105 when leaving the store and retailer 101 can create a record of the in-store behavior of customer 101 using this information. The UPC codes can be downloaded, for example, by inserting the PDA into a cradle which communicatively couples the PDA to computer system 105, or by using a wireless communications device coupled with the PDA which downloads the UPC codes to a wireless device coupled with computer system 105.

In another embodiment, system 104 comprises customer 102 wirelessly querying a device associated item 103. For example, many PDAs are coupled with a Bluetooth device which allows the PDA to communicate in a wireless network. Bluetooth is the code name for a technology specification for small form factor, low-cost, short-range radio links between personal computers, mobile phones and other devices and appliances. The Bluetooth technology replaces the cables that typically connect one device to another with short-range radio links. Bluetooth connections are generally ad hoc connections made between devices only for the length of time needed to accomplish a specific, perhaps time-limited communications session. Once the communications session is completed, the connection is broken. Normally, the range of Bluetooth links is set to approximately ten meters. However, to support other uses, the range of Bluetooth links can be augmented to extend the range up to 100 meters.

For example, in one embodiment a Bluetooth device is attached to item 103 in a manner similar to a sales tag. Customer 102 can query the Bluetooth device and receive onto their PDA information which identifies item 103. This identification information can be stored on the PDA of customer 102 and downloaded into computer system 105 when customer 102 leaves the store.

Computer system 105 is used to store information about customer behavior which will be used to customize the content of targeted advertising based upon the items in which customer 102 has expressed an interest. In one embodiment, computer system 105 comprises a data storage 106 and a computer 107 which is used to create customized targeted advertising. In one embodiment, the customized advertisement is a Web page published on Internet 108. In another embodiment, the customized advertisement is a printed advertisement 117 created on a printing system 110 coupled with computer system 105. While the present invention recites these media for communicating a targeted advertisement to a customer, the present invention is well suited to utilize other communications media as well.

In one embodiment, the data of the in-store behavior of customer 102 is used to create a customized targeted advertisement 111 which communicates information about item 103 via Internet 108. In one embodiment, targeted advertisement 111 is a Web page having customized content based upon the in-store behavior of customer 102. For example, customer 102 can go to the Web site of retailer 101 from their home 112. Customer 102 can provide a name and identification number to be directed to a customized Web page 111. Web page 111 is customized by retailer 101 to provide information about item 103 in which customer 102 had previously expressed an interest. In another embodiment, targeted advertisement 111 is a customized E-mail message which is sent to customer 102 having information about item 103. In so doing, the present invention provides a method for customizing the content of targeted advertising which is based upon the in-store behavior of a customer.

A second customer 113 can express an interest in an item offered by retailer 101 and receive a second targeted advertisement 114. For example, customer 113 can go to the Web site of retailer 101 from their home 115 and provide a name and identification number to be directed to a customized targeted advertisement 114. Targeted advertisement 114 can be a Web page or E-mail having customized content based upon the in-store behavior of customer 113.

A third customer 116 expresses an interest in an item offered by retailer 101 and receives a printed advertisement 117 at their home 11 8. Printed advertisement 117 contains information about an item and/or related items which may be of interest to customer 116. The content of printed advertisement 117 is customized according to the in-store behavior of customer 116. Previously, customized mass mailing advertising was not economically feasible for most advertisers. Therefore, the content of the advertisement was directed to demographic groups as a whole rather than individual consumers. However, embodiments of the present invention utilize computer controlled printing systems to facilitate customizing the content of targeted advertising by identifying customer specific content for the advertisements and provide the capability for printing a customized message for each recipient.

Thus, the present invention facilitates customizing the content of targeted advertising based upon a customer's in-store behavior. The retailer can use this in-store behavior information to accurately identify smaller demographic groups. Additionally, the present invention facilitates customizing the content of targeted advertising to the level of the individual customer. This allows the retailer to customize the content of their advertising to address the unique needs and interests of the individual customer which makes the advertising much more effective in reaching receptive audience. Therefore, embodiments of the present invention can reduce the costs of advertising because advertisers can now send smaller advertisements which are customized to the individual customer's expressed interests.

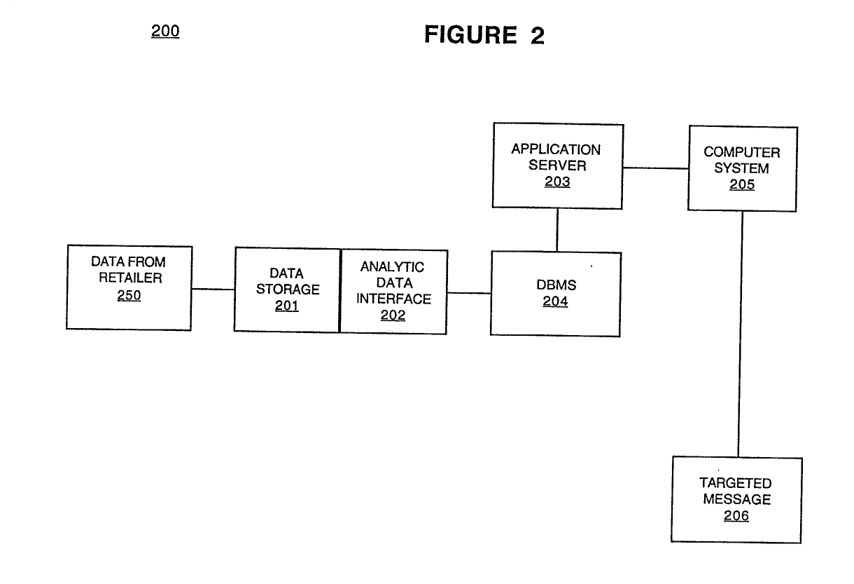

FIG. 2 illustrates one embodiment of a system 200 which can be used for customizing the content of targeted advertising in accordance with embodiments of the present invention. Data 250 from data sources (e.g., retailer 101) is received into data storage 201. In various embodiments of the present invention, data 250 includes the item of expressed interest as well as other customer specific information. The customer specific information can include contact information about a customer that enables a retailer to deliver the targeted message to the customer (e.g., the customer's home address, E-mail address, or other information which uniquely identifies the customer to the retailer). Typically, data storage 201 uses a high capacity mass storage device such as a disk drive, optical drive, tape drive, etc. In one embodiment, data storage 201 is a data warehouse which is coupled to a database management system (DBMS) 204 by analytic data interface 202. DBMS 204 is used to execute a data analysis application such as a categorization application. In one embodiment, an application server 203 can be interposed between the DBMS 204 and a computer system 205. Application server 203 may incorporate DBMS 204, or these may be separate entities. In one embodiment, computer system 205 is a Web server which delivers targeted advertisement 206 in the form of a customized Web page. In another embodiment, computer system 205 is a computerized printing system used to create a targeted message in the form of a printed advertisement.

In one implementation of the present invention, a record is created on data storage 201 of a customers in-store behavior. For example, the customer designates an item of expressed interest and indicates to a retailer that they would like to receive more information about this item. In one embodiment, the retailer creates a category using DBMS 204 which associates the item of expressed interest with other related items according to shared attributes of the items.

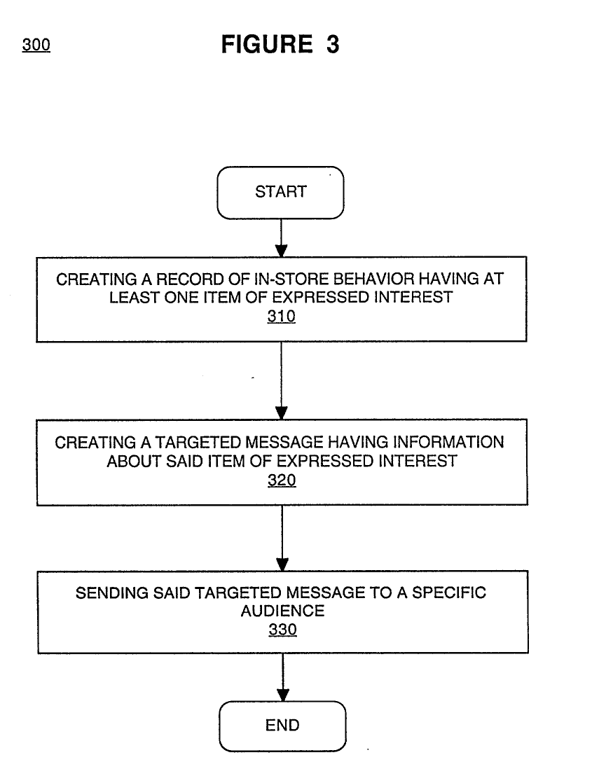

FIG. 3 is a flow chart 300 of a method for customizing the content of targeted advertising in accordance with embodiments of the present invention. In step 310 of FIG. 3, a record is created of in-store behavior having at least one item of expressed interest. In one embodiment of the present invention, a customer identifies an item as an item of expressed interest and indicates that they would like to receive more information about the item of expressed interest and/or related items. The item of expressed interest may be a product or service purchased by a customer or a product or service in which the customer has otherwise indicated some interest. For example, customers will often defer purchasing a product until they can compare the price or performance with similar products. Using the present invention, a retailer can communicate pertinent information to a customer by customizing the content of targeted advertising to include information about the item of expressed interest as well as related items and thus allow the customer to compare products before purchasing them.

Referring to step 320 of FIG. 3, a targeted message is created which has information about the item of expressed interest. According to embodiments of the present invention, the content of the targeted message is customized to convey information about the item of expressed interest and/or similar items to the customer. Additionally, the content of the targeted message may contain information about other items which may be used in conjunction with the item of expressed interest. In one embodiment, the targeted message can include information which describes how an item can be used in conjunction with items previously purchased by the customer. For example, if a customer previously purchased a home computer system, and identifies to the same retailer, a digital camera as an item of expressed interest, the retailer can include information in the targeted message which tells the customer how the item of expressed interest can be used with their home computer system.

Referring to step 330 of FIG. 3, the targeted message is sent to a specific audience. In one embodiment, the targeted message is a Web page which is customized to communicate information about the item of expressed interest. For example, a customer accessing the main page of a retailer's Web site can enter a unique identification and be directed to a Web page having customized content which contains information about the item of expressed interest and/or related items. In another embodiment, the targeted message is an E-mail message which is customized to communicate information about the item of expressed interest and/or related items. Thus, in accordance with one embodiment of the present invention, a targeted message is sent to a specific customer, the content of which has been chosen based upon the customer's previous in-store behavior. The content of the customized Web page can easily be updated in response to the customer identifying an item and thus allows the retailer to address the customer's unique interests based upon their in-store behavior.

In another embodiment, the targeted message is a printed advertisement which is customized to communicate information about the item of expressed interest. Previously, customized mass mailing advertising was not economically feasible for most advertisers. Therefore, the content of the advertisement was directed to demographic groups as a whole rather than individual consumers. However, computer controlled printing systems facilitate customizing the content of targeted advertising to the individual due to their ability to quickly change the content of the documents they create. Embodiments of the present invention facilitate customizing the content of customized mass mailing advertising by identifying customer specific information which can be used to customize the content of advertisements.

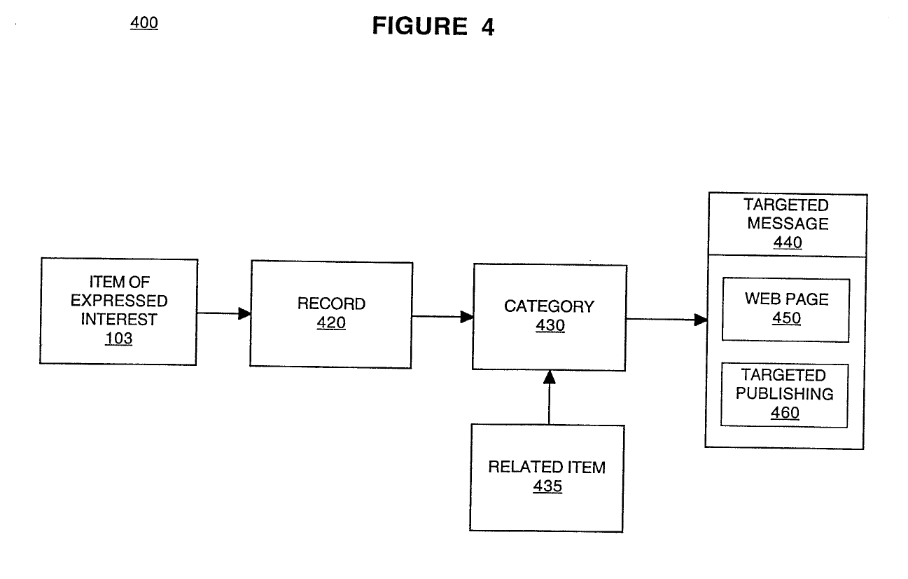

FIG. 4 is a block diagram of a method for customizing the content of targeted advertising in accordance with embodiments of the present invention. A record 420 is created of in-store behavior of a customer (e.g., customer 102 of FIG. 1). In accordance with embodiments of the present invention, record 420 has information recording at least one item of expressed interest (e.g., item 103 of FIG. 1). Customer 102 indicates to retailer 101 that they are interested in item 103 and would like to receive information about item 103 and/or related items. Item 103 can be a product or service purchased by customer 102 or an item or service in which customer 102 has otherwise indicated some interest. For example, customers will often defer purchasing an item until they can compare the price or performance with similar products. Using the present invention, a retailer can communicate pertinent information to a customer by customizing the content of targeted advertising to include information about item 103 as well as relate items and thus allow the customer to compare products before purchasing them.

In one embodiment of the present invention, a category 430 is created which associates item 103 with at least one related item 435. Categorization can be defined as grouping items according to shared attributes. In one embodiment of the present invention, the retailer assigns attributes to items (e.g., products or services) offered by their store. For example, a blender can be categorized under the heading of consumer electronics and sub-categorized as a kitchen appliance, etc. It is appreciated that there are a variety of categorization methods which can be used in accordance with the present invention. In addition to including items which are similar to item 103, category 430 may also include items that can be used in conjunction with item 103. For example, if item 103 is a television, category 430 may also include Digital Video Disk (DVD) devices, or other items which may be used in conjunction with the television. In another embodiment, category 430 can be used to more accurately identify small demographic groups that receive targeted advertising that is customized based upon their in-store behavior rather than individual customers.

A targeted message 440 is created which has information about category 430. According to embodiments of the present invention, the content of targeted message 440 is customized to convey to the customer, information about items in category 430. For example, in one embodiment the content of targeted message 440 contains information about item 103 and/or information about similar products or services (e.g., related items 435) within category 430. Additionally, the content of targeted message 440 may contain information about other items which may be used in conjunction with item 103. In one embodiment, targeted message 440 can include information which describes how an item in category 430 can be used in conjunction with items previously purchased by the customer. For example if customer 102 previously purchased a home computer system from retailer 102, and identifies to retailer 101 a digital camera as item 103, retailer 101 can include information in targeted message 440 which tells customer 102 how item 103 can be used in conjunction with their previously purchased home computer system.

As mentioned above, in one embodiment, targeted message 440 is a Web page 450 which is customized to communicate information about category 430. The content of Web page 450 can easily be updated in response to a customer identifying an item in which they are interested and thus allow retailers to address the customer's unique interests based upon their in-store behavior. For example, retailer 101 can store a plurality of Web pages about the products or services they offer on their Web server (e.g., computer system 205 of FIG. 2). When customer 102 provides some form of identification, category 430 is searched for a list of items in which customer 102 has expressed an interest as well as any related items. The individual Web pages of these items are combined and presented to customer 102 as a customized Web page. In a similar manner, a printed advertisement 460 can be sent to customer 102. In this embodiment, a computerized printing system is used to control and customize the content of printed advertisement 460.

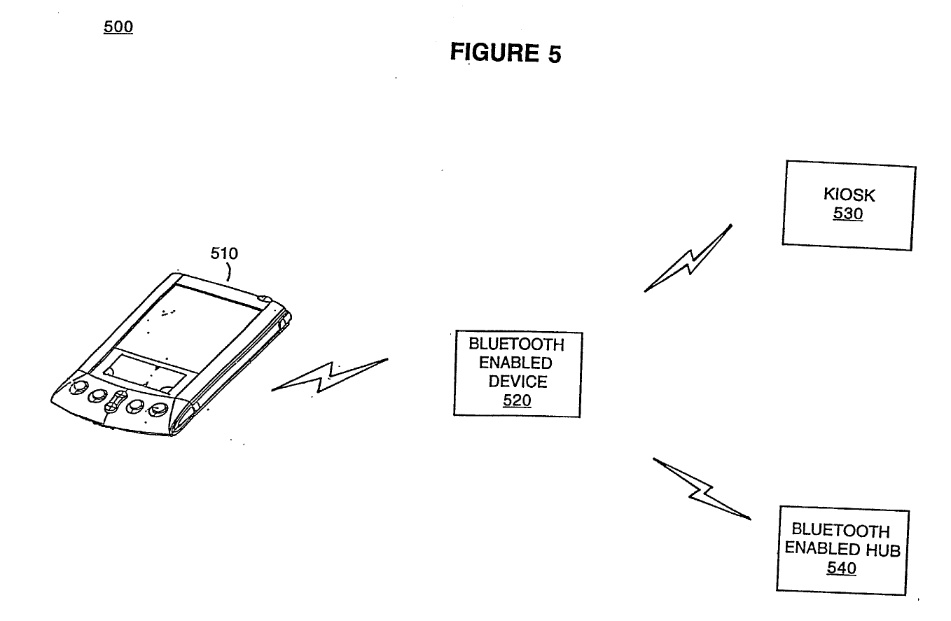

FIG. 5 illustrates system utilizing a Bluetooth enabled device to identify an item of expressed interest in accordance with embodiments of the present invention. In one embodiment, a customer can utilize a Bluetooth enabled Personal Digital Assistant 510 to initiate communications with a Bluetooth enabled device 520. In one embodiment, Bluetooth device 520 is attached to an item (e.g., item 103 of FIG. 1) in a retail store. Alternatively, Bluetooth device 520 can be in the vicinity of item 103 and in some manner indicate that it is associated with item 103. The customer can initiate communications with Bluetooth device 520 to get information identifying item 103 with which Bluetooth device 520 is associated. The customer can store this information on PDA 510 as well as information about other items until they leave the store. The customer can then download the information identifying item 103 into kiosk 530. In one embodiment, this downloading can be accomplished wirelessly, for example by initiating Bluetooth communications with kiosk 530 and sending the information identifying item 103 wirelessly. In another embodiment, PDA 510 can be inserted into a cradle of kiosk 530 which communicatively couples PDA 510 to the computer system (e.g., system 200 of FIG. 2) of the retailer.

In another embodiment, the customer can store personal identity information on PDA 510. When the customer sees an item of interest, they can wirelessly transmit this identity information to Bluetooth device 520. Bluetooth device 520 can be coupled with the computer system of retailer 101 and create a record associating the customer identity information with the particular product device 520 is associated. Alternatively, Bluetooth device 520 can wirelessly transmit this data to a Bluetooth enabled hub 540 which is coupled to the retailers computer system.

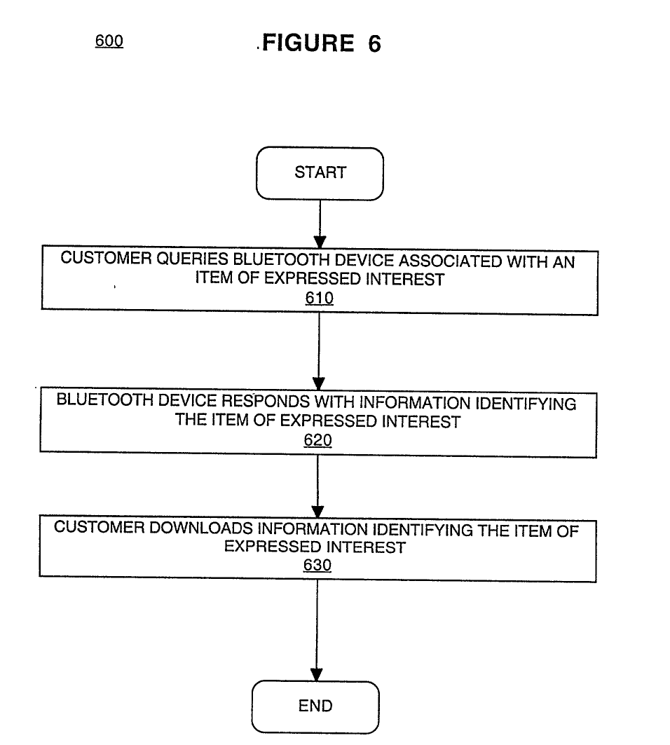

FIG. 6 is a flow chart of an exemplary method for identifying an item of expressed interest (e.g., item 103 of FIG. 1) in accordance with one embodiment of the present invention In step 610 of FIG. 6, a customer (e.g., customer 103 of FIG. 1) queries a Bluetooth enabled device 520 attached to an item of expressed interest (e.g., item 103 of FIG. 1). In one embodiment of the present invention, a customer uses a Bluetooth enabled PDA (e.g., PDA 510 of FIG. 5) to initiate a wireless communications session with Bluetooth device 520. Bluetooth device 520 can, for example, be attached to item 103 in a manner similar to a sales tag. Alternatively, Bluetooth device 520 can be in the vicinity of item 103 and in some manner indicate to customer 102 that it is to be queried in order to identify item 103.

In step 620 of FIG. 6, Bluetooth device 520 responds wirelessly to the customer query of step 610 with information identifying item 103. Bluetooth enabled device 520 can be configured to automatically respond to a properly formatted query with information identifying item 103. For example, Bluetooth device 520 can send a UPC code to PDA 510 which uniquely identifies item 103. While the present embodiment recites using a UPC code, the present invention is well suited to utilize a variety of methods for identifying item 103.

In step 630 of FIG. 6, the customer downloads information identifying item 103. For example, this can be accomplished by providing a kiosk 530 in the store to which the customer downloads the information received in step 620 from PDA 510. Kiosk 530 can be equipped with a Bluetooth device which allows the customer to wirelessly transmit the information identifying item 103 as well as information identifying the customer to the retailer. Alternatively, kiosk 530 can have a communications port coupled with a cradle for receiving and initiating communications with PDA 510. The cradle provides an electrical and mechanical communications interface to two-way communications between PDA 510 and kiosk 530. Kiosk 530 can be connected to the retailers computer network (e.g., system 200 of FIG. 2) and the downloaded information is then used to create a record (e.g., record 420 of FIG. 4) which is used to create the customized content of targeted message 440.

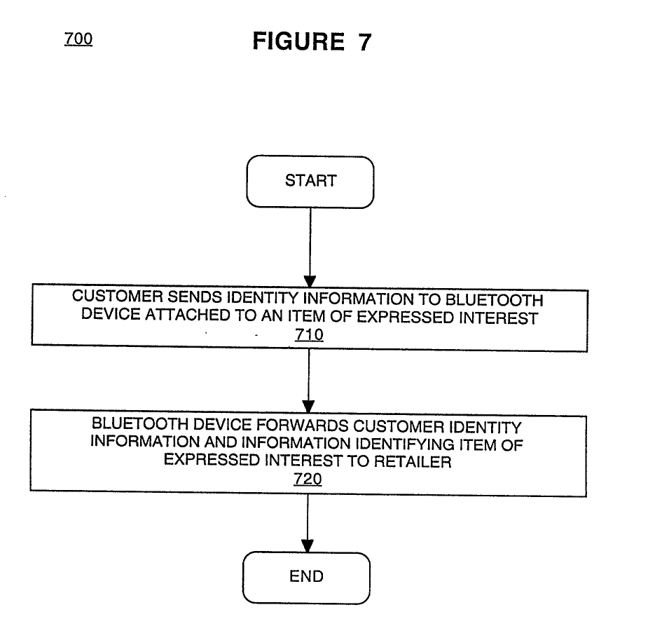

FIG. 7 is a flow chart of an exemplary method for identifying an item of expressed interest (e.g., item 103 of FIG. 1) in accordance with one embodiment of the present invention In step 710 of FIG. 7, a customer sends identity information to a Bluetooth device attached to item 103. In the embodiment of FIG. 7, identity information (e.g., a customer's name and address) is stored on their PDA (e.g., PDA 510 of FIG. 5). When the customer sees an item (e.g., item 103) in a store in which they are interested, they can initiate a Bluetooth communications session with Bluetooth enabled device 520 attached to item 103. Upon establishing communications with Bluetooth device 520, the customer's identity information is automatically sent to Bluetooth device 520.

In step 720 of FIG. 7, Bluetooth device 520 forwards the customer identity information and information identifying item 103 to a retailer. Upon receiving the customer's identity information, this information and information identifying item 103 is automatically forwarded by Bluetooth device 520. In one embodiment, Bluetooth device 520 is coupled with the computer system of retailer 101. In another embodiment, this information can be transmitted to a Bluetooth enabled hub 540 located in the store. Bluetooth enabled hub 540 can be connected to a retailers computer network (e.g., system 200 of FIG. 2). This information is then used to create a record (e.g., record 420 of FIG. 4) in order to create the customized content of targeted message 440 that will be sent to the customer.

In summary, embodiments of the present invention allow retailers to customize the content of targeted advertisements they send to customers based upon the customer's in-store behavior. Because the customer identifies the items in which they are interested, the retailer can leverage this information to create advertisements which are tailored to the customer's unique preferences. This allows advertisers to see a greater return from their advertising budgets. For example, advertisements can be made smaller because they can be customized to convey information to the customer about products in which they have indicated some interest. This reduces the cost of printing and distributing advertising. Additionally, because the customer has already indicated some interest in the product being advertised, the advertisement in more likely to generate sales for the advertiser.

The preferred embodiment of the present invention, a method and system for customizing the content of targeted advertising based upon in-store behavior, is thus described. While the present invention has been described in particular embodiments, it should be appreciated that the present invention should not be construed as limited by such embodiments, but rather construed according to the following claims.

What is claimed is:

1. A method for customizing the content of targeted advertising comprising:
creating a record of in-store behavior having at least one item of expressed interest;
creating a targeted message comprising information about said item of expressed interest; and
sending said targeted message to a specific audience.

2. The method for customizing the content of targeted advertising as recited in claim 1 further comprising:
creating a category wherein said item of expressed interest is associated with at least one related item; and
sending information about said related item in said targeted message.

3. The method for customizing the content of targeted advertising as recited in claim 2, wherein said creating of said targeted message comprises creating a customized Web page having said information about said item of expressed interest and said related item in said category.

4. The method for customizing the content of targeted advertising as recited in claim 2, wherein said creating of said targeted message comprises printing a customized advertisement having said information about said item of expressed interest and said related item in said category.

5. The method for customizing the content of targeted advertising as recited in claim 1, wherein said record of in-store behavior is unique to a customer and further comprising said customer identifying said item of expressed interest.

6. The method for customizing the content of targeted advertising as recited in claim 1, wherein said creating of said record comprises recording an in-store purchase of said item of expressed interest.

7. The method for customizing the content of targeted advertising as recited in claim 1, wherein said creating of said record comprises identifying said item of expressed interest wirelessly using a handheld electronic device.

8. The method for customizing the content of targeted advertising as recited in claim 7, wherein said handheld electronic device is a Personal Digital Assistant (PDA) and said creating of said record comprises identifying said item of expressed interest using said Personal Digital Assistant.

9. A method for customizing the content of targeted advertising based upon in-store behavior comprising:
recording in-store behavior wherein a purchasing entity identifies an item of expressed interest;
creating a category which groups said item of expressed interest with at least one related item; and
creating a targeted message which is unique to said purchasing entity and wherein information is conveyed to said purchasing entity about said item of expressed interest and said related item in said category.

10. The method for customizing the content of targeted advertising as recited in claim 9, wherein said recording of said in-store behavior is performed wirelessly by said purchasing entity using a handheld electronic device.

11. The method for customizing the content of targeted advertising as recited in claim 10, wherein said recording of said in-store behavior is performed by said purchasing entity using a Personal Digital Assistant.

12. The method for customizing the content of targeted advertising as recited in claim 9 further comprising:
associating said item of expressed interest with an item previously purchased by said purchasing entity; and
creating a targeted message for said purchasing entity describing how said item of expressed interest can be used in conjunction with said previously purchased item.

13. The method for customizing the content of targeted advertising as recited in claim 9, wherein said creating of said targeted message comprises creating a customized Web page which is unique to said purchasing entity.

14. The method for customizing the content of targeted advertising as recited in claim 9, wherein said creating of said targeted message comprises printing a customized advertisement which is unique to said purchasing entity.

15. A system for customizing the content of advertising based upon in-store behavior comprising:
means for collecting in-store information wherein at least one item of expressed interest is identified by a purchasing entity;
means for creating a category wherein said item of expressed interest is associated with at least one related item; and
means for creating a targeted message which is unique to said purchasing entity and wherein information about said category is communicated.

16. The system for customizing the content of advertising based upon in-store behavior of claim 15, wherein said means for collecting in-store information comprises an electronic means for wirelessly identifying said item of expressed interest.

17. The system for customizing the content of advertising based upon in-store behavior as recited in claim 15, wherein said means for creating said targeted message comprises means for creating a Web page which is unique to said purchasing entity.

18. The system for customizing the content of advertising based upon in-store behavior as recited in claim 15, wherein said means for creating said targeted message comprises means for creating a customized printed advertisement which is unique to said purchasing entity.
